(19) United States
(12) Patent Application Publication
(10) Pub. No.: US 2008/0143192 A1
(43) Pub. Date: Jun. 19, 2008

(54) Dynamic radio frequency power harvesting

(76) Inventors: Alanson P. Sample, Seattle, WA (US); Joshua R. Smith, Seattle, WA (US)

Correspondence Address: TROP PRUNER & HU, PC, 1616 S. VOSS ROAD, SUITE 750, HOUSTON, TX, 77057-2631, US

(21) Appl. No.: 11/639,091

(22) Filed: Dec. 14, 2006

(51) Int. Cl. H02J 17/00

(52) U.S. Cl. 307/149

(57) ABSTRACT

A single circuit may, in some embodiments, provide both static and dynamic power harvesting. The dynamic harvesting using switched transistors may be powered by the static harvesting circuit in one embodiment. That is, during a first phase, power may be generated in a static harvesting mode using diodes. That power generated in the first phase may be used in a second phase for dynamic power harvesting using transistors arranged in parallel to the diodes. The use of the transistors may, in some embodiments, result in the harvesting of more power. In some cases, the same capacitors may be used for both active and static harvesting.

### BACKGROUND

This relates generally to harvesting power from radio frequency signals.

A number of radio frequency devices may be operated at remote locations. In addition, some of these devices may be mobile. Therefore, a readily available, continuous source of power may not be possible. One way to power these devices is to power them from the radio frequency signal they receive using a technique called radio frequency power harvesting.

One application for radio frequency power harvesting is radio frequency identification (RFID) technology which may be used in public transportation, logistics, airline baggage tracking, asset tracking, inventory control and tracking, tracking goods in supply chains, tracking parts, security, access control and authentication, to mention just a few examples. Another application for radio frequency power harvesting is in connection with wirelessly powered embedded microprocessors and sensors.

One reason radio frequency identification tags are a good application for a radio frequency power harvesting is that their power requirements are relatively modest. However, radio frequency power harvesting may be used in a variety of other applications as well.

A simple radio frequency identification system may use a reader and passive tags that work with shorter range and lower frequency, while longer distance applications may use active tags. A radio frequency identification tag may be an integrated circuit with a tag insert or an inlay including an integrated circuit attached to an antenna. A reader/writer sends out electromagnetic waves to the tag that induce a current in the tags' antenna.

The reader/writer may be a fixed or portable device. The tag modulates the wave and may send information back to the reader/writer. Additional information about the items the tag is attached to can be stored on the tag.

Passive tags typically have no power source and rely on the energy delivered by the interrogation signal to transmit a stream of information. Active tags may have a power source such as a direct current battery. Semi-passive tags may have a battery that is used for only part of the tag's power needs.

Information may be exchanged between the tag and the reader/writer through either inductive coupling or back-scatter. Many different frequencies may be utilized for these systems, but the most common current frequencies are around 165 KHz, 13.56 MHz, 902 to 928 MHz, and microwave.

### BRIEF DESCRIPTION OF THE DRAWINGS

FIG. 1 is a system depiction of an RFID system according to one embodiment;

FIG. 2 is a circuit diagram for an RF power harvesting circuit in accordance with one embodiment;

FIG. 3 is a graph of simulated voltage over time for three signals including a carrier wave from the RFID signal and two square wave signals derived therefrom;

FIG. 4 is a plot of simulated voltage versus current for dynamic versus static devices for harvesting power; and

FIG. 5 shows a graph of simulated voltage versus time for a device that switches between a static power harvesting mode and a dynamic power harvesting mode.

### DETAILED DESCRIPTION

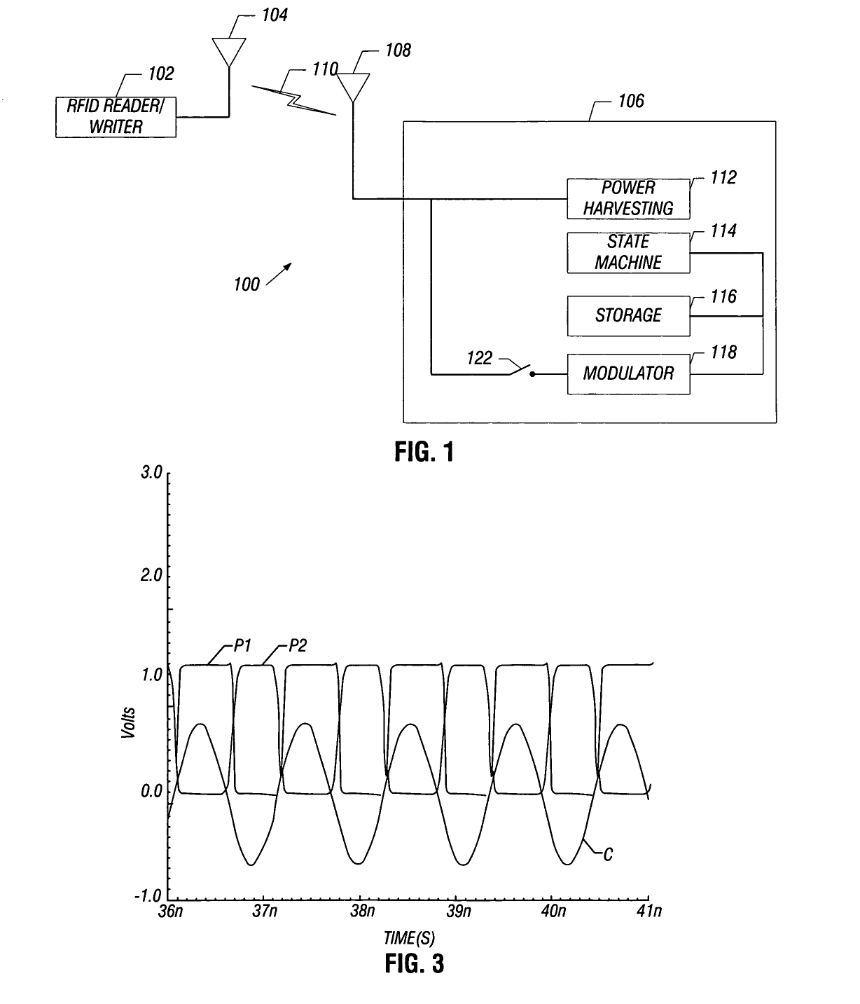

Referring to FIG. 1, a radio frequency identification (RFID) system 100 includes a radio frequency identification reader/writer 102 having an antenna 104 and a radio frequency identification device 106 having an antenna 108. Any of a number of different low profile antenna tags may be used for the antenna 104 and antenna 106, including, for example, dipole, loop, patch, or other antennas.

The device 106 receives and processes a radio frequency signal 110 from the reader/writer 102. The device 106 may include power harvesting and voltage processing circuitry 112, a processor or state machine 114, a storage 116, and a modulator 118. The power harvesting and voltage processing circuit 112 may include circuitry for harvesting power to operate the device 106 from the radio frequency signal 110.

The storage 116 may contain a key for decryption, a device identification for signal authentication, or other information. The modulator 118 may control the switch 122 and may be used for upstream communications in some embodiments.

To access the device 106, an interrogation signal may be transmitted by the reader/writer 102 in the vicinity of the device 106. Upon receipt of the interrogation signal, the device 106 may respond by dynamically modulating the impedance of its antenna 108 to encode response information. The antenna 108 may be tuned for whatever impedance is convenient from an antenna design perspective.

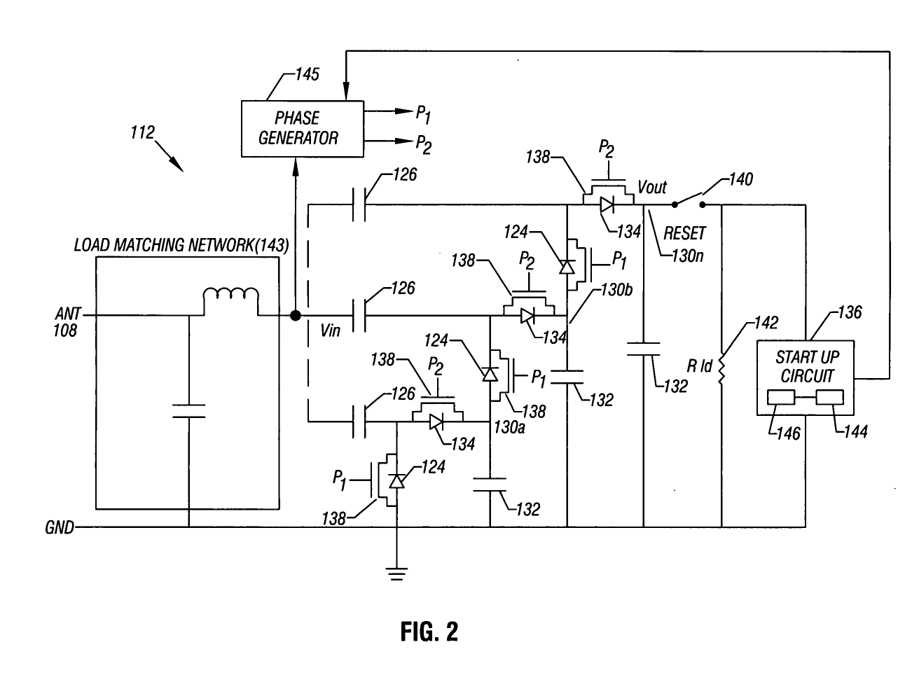

Referring to FIG. 2, the power harvesting circuit 112, in accordance with one embodiment, may have connections to the antenna 108 and to ground. The signal from the antenna 108 may be passed through a load matching network 143 that may include an inductor and a capacitor. The load matching network 144 may maximize the power delivery to the harvesting circuitry and may improve power harvesting and communications efficiency. Other matching networks may be used.

The signal output from the network 143, Vᵢₙ, may be coupled to each of three capacitors 126. Each capacitor 126 may be coupled to a diode 134. The diodes 134 may be implemented as diode connected transistors in some embodiments. The diodes 134 may be coupled in parallel to an active, gate-controlled transistor switch 138. The transistor switch 138 may be controlled by a gate signal P2 or P1. The generation of signals P1 and P2 by the generator circuit 145 in FIG. 2 may be enabled by a startup circuit 136. In one embodiment, P1 and P2 may be generated from the input RF signal, passed through two cascaded inverters to produce a thresholded signal (i.e. a square wave), and a second square wave 180 degrees out of phase. P1 and P2 may also be produced by a Phase Locked Loop (PLL) or by a Delay Locked Loop (DLL).

A reset switch 140 may be provided in some embodiments. The load resistor 142 illustrates the load to which power is being supplied, for example, a microcontroller or RFID tag.

A number of other transistors 138 can receive the signal P1 from the P1 and P2 generator circuit 145. The signals P1 and P2 are out of phase with one another. As shown in FIG. 3, a carrier wave C, provided in the signal 110, may be thresholded and buffered or inverted to form the thresholded positive and negative signals P1 and P2. One of those signals P1, P2 is produced by a first of two series connected inverters and the other of the signals is provided by the second of two series connected inverters.

In the embodiment shown in FIG. 2, a series of three voltage doubler circuits 130a, 130b, and 130C in cascade are provided. However, any number of voltage doubler circuits may be utilized. In addition, while the depicted circuits are based on the so-called Villard voltage doubler, also known as the Cockcroft-Walton voltage multipler, a Dickson voltage multiplier may also be utilized. As used herein, a voltage doubler circuit may double or multiply a voltage.

The voltage doubler 130 generally includes a first paired diode 134 and a capacitor 132 to rectify a positive cycle of the applied radio frequency signal and then a second paired diode 124 and capacitor 126 to rectify that signal in the negative cycle. During the positive cycle, the voltage stored on the capacitor 126 in the negative cycle is transferred to the capacitor 132 used in the positive cycle. Thus, the voltage on the capacitor 132 used in the positive cycle is ideally doubled. The voltage multiplication may be increased by cascading a series of such inverter multipliers. In some embodiments, complementary metal oxide semiconductor (CMOS) diode-connected transistors are used instead of diodes.

By using dynamic switching transistors 138 in parallel with or instead of the diodes 124 and 134, the diodes 134 may be used in a first mode (with the transistors set to a high impedance state), to provide a static power source to supply power subsequently to the transistors 138 that provide more effective dynamic switching during a second mode.

The startup circuit 136, powered by the static mode operation of the harvester using the diodes 134, then enables generation of the two thresholded signals P1 and P2, which are 180° out of phase, to power selected ones of the transistor switches 138 during the second mode. Thus, the startup circuit 126 includes a voltage monitor 146 and a controller 144 that supplies a voltage to the phase generator 145 after the voltage across the startup circuit 136 reaches a predetermined level. Until that point, NMOS transistors 138 receive 0 volts, setting them to a high impedance state.

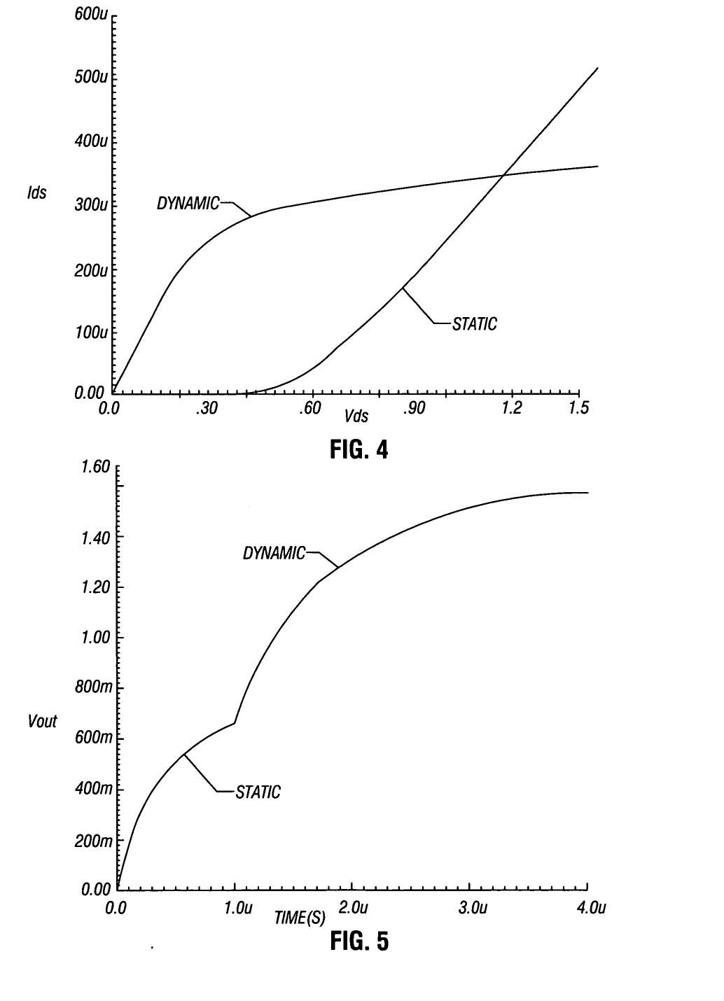

Referring to FIG. 4, the effect of dynamic versus static operation is depicted. The dynamic curve using the transistors rises much more quickly, in some embodiments, than the static curve which uses diodes only. Thus, the dynamic switches can theoretically generate additional power.

This enhancement is further illustrated in FIG. 5 which shows one mode of the operation of the circuit 112 shown in FIG. 2. Initially, the circuit 112 is powered only by the static diodes 124 and 134. In this mode, the transistors 138 are set to a high impedance state. Then, when sufficient charge is accumulated, the startup circuit 136 enables dynamic operation using the transistors 138 controlled by the out-of-phase signals P1 and P2 supplied by phase generator 145. In one embodiment, in the static mode, the startup circuit 136 holds control signals P1 and P2 in the zero state until enough energy is accumulated to operate in the dynamic harvesting phase using the transistors 138 driven by the signals P1 and P2.

Thus, the same capacitors 126 and 132 may be used in both the static and dynamic operation, while at different times and in different phases. This sharing of capacitors may reduce cost and circuit footprint in some embodiments. In one embodiment, a battery may be used to supply power for the dynamic mode.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
operating transistors using a pair of out-of-phase signals to dynamically harvest power from a radio frequency signal.

2. The method of claim 1 comprising:
harvesting power from the radio frequency signal using diodes in a first mode; and
using the power harvested in the first mode to operate said transistors to dynamically harvest power from the signal during a second mode.

3. The method of claim 2 including providing a voltage doubler circuit including diodes with parallel switched transistors.

4. The method of claim 3 including controlling said switched transistors using out-of-phase signals.

5. The method of claim 4 including controlling said transistors using out-of-phase signals derived from the radio frequency signal.

6. The method of claim 5 including using one of a phase locked loop or a delay locked loop to generate said out-of-phase signals.

7. The method of claim 3 including using a voltage doubler circuit including capacitors, and using the same capacitors in the first and second modes.

8. The method of claim 2 including setting said transistors into a high impedance state during said first mode.

9. The method of claim 8 including dynamically switching said transistors in said second mode.

10. The method of claim 2 including monitoring the power developed during said first mode and when a predetermined power level is developed, switching to said second mode.

11. The method of claim 2 including harvesting power for radio frequency identification.

12. The method of claim 5 including generating the out-of-phase signals by series connected inverters.

13. A radio frequency power harvesting circuit comprising:
a voltage doubler circuit;
said voltage doubler circuit including a pair of diodes and a pair of capacitors; and
a transistor coupled in parallel to each of said diodes.

14. The circuit of claim 13 including generating the out-of-phase signals by series connected inverters.

15. The circuit of claim 13 including at least two cascaded voltage doubler circuits.

16. The circuit of claim 13 to operate statically in a first mode using said diodes and dynamically using said transistors in a second mode.

17. The circuit of claim 16 including a device to switch the circuit between static and dynamic modes.

18. The circuit of claim 17 wherein said device to initially operates said circuit in a static mode and then switches said circuit to a dynamic mode.

19. The circuit of claim 18 wherein said device operates said circuit in said static mode until sufficient power has been developed to operate the device in said dynamic mode including said transistors.

20. The circuit of claim 19 including developing out-of-phase signals from a received radio frequency signal.

21. The circuit of claim 20, said device to provide said signals to different transistors.

22. The circuit of claim 21 wherein said device sets said transistors to a high impedance state initially and then enables them thereafter to provide an additional current path in parallel with said diodes.

23. The circuit of claim 17 wherein said capacitors are used in said static and dynamic modes.

24. A radio frequency identification tag comprising:
a controller; and
a power harvesting circuit coupled to said controller, said power harvesting circuit including a voltage doubler circuit having a pair of diodes and a pair of capacitors, a transistor coupled in parallel to each of said diodes.

25. The tag of claim 24 including a plurality of cascaded doubler circuits.

26. The tag of claim 24 to operate statically in a first mode using said diodes and dynamically using said transistors in a second mode.

27. The tag of claim 26 including a device to switch the circuit between static and dynamic modes.

28. The tag of claim 27 wherein said device operates said circuit in said static mode until sufficient power has been developed to operate the device in said dynamic mode including said transistors.
